(19) United States
(12) Patent Application Publication
(10) Pub. No.: US 2015/0035736 A1
(43) Pub. Date: Feb. 5, 2015

(54) METHOD FOR COMPENSATING VOLTAGES AND ORGANIC LIGHT EMITTING DIODE DISPLAY USING THE SAME

(71) Applicant: CHUNGHWA PICTURE TUBES, LTD., Padeh City (TW)

(72) Inventors: Chia Yi LU, Zhongli City (TW); Chin-I CHIANG, Taipei City (TW)

(73) Assignee: CHUNGHWA PICTURE TUBES, LTD., Padeh City (TW)

(21) Appl. No.: 14/082,014

(22) Filed: Nov. 15, 2013

(30) Foreign Application Priority Data
Aug. 2, 2013 (TW) 102127747

(51) Int. Cl. G09G 3/32

(52) U.S. Cl. CPC G09G 3/3216
USPC 345/82

(57) ABSTRACT

A method for compensating voltages includes steps as follows. A reference voltage line is detected to obtain a first pulsation signal. A phase of the first pulsation signal is shifted to obtain a shift signal. The shift signal is compared with an ideal signal to obtain a difference signal. A phase of difference signal is inverted, and the phase-inverted difference signal is summed up with the ideal signal, so as to obtain a compensation signal. The compensation signal is outputted to the reference voltage line when the reference voltage line sends a second pulsation signal, so that a voltage of the reference voltage line becomes the ideal signal, wherein the ideal signal is a fixed voltage.

### CROSS-REFERENCE TO RELATED APPLICATION

This application claims the benefit of Taiwan Patent Application No. 102127747, filed on Aug. 2, 2013, which is hereby incorporated by reference for all purposes as if fully set forth herein.

### BACKGROUND OF THE INVENTION

1. Field of the Invention

The present invention relates to an organic light emitting diode (OLED) display, and more particularly to an OLED display in which a method for compensating voltages is used in order to improve display uniformity.

2. Related Art

FIG. 1 is a pixel unit circuit diagram of a conventional OLED display. The operation principle of the pixel unit 900 is substantially as follow: when the control signal G. makes the switching thin-film transistor (TFT) T₁ ON, the date signal DATA will be stored in the capacitor Cs. In addition, when the control signal G. makes the switching TFT T₁ OFF, the driving TFT T₂ will be ON and generate a corresponding driving current to drive the OLED OD1 based on the voltage stored in the capacitor Cs. As shown in FIG. 1, the reference power source V_{dd} of the OLED OD₁ is a positive voltage, and the reference voltage Vₛₛ can be a ground potential or a negative potential.

As the formula (1) shown below, it denotes the driving current I_{OLED} which passes through the OLED OD1.

I_{OLED}=K(V_{GS}−Vₜₕ)²=K(V_{G}−V_{S}−Vₜₕ)²=K(V_{DATA}−V_{OLED}−V_{SS}−Vₜₕ)² Formula (1)

Wherein, K is a process parameter (constant) of the driving TFT T2; V_{GS} is a voltage between the gate and the source of the driving TFT T2; Vₜₕ is a threshold voltage of the driving TFT T2; V_{G} is a gate voltage of the driving TFT T2; Vₛ is a source voltage of the driving TFT T2; V_{DATA} is a data signal voltage; V_{OLED} is a voltage between two ends of the OLED OD1; and Vₛₛ is a reference voltage.

Referring to FIG. 2 simultaneously, when the driving TFT T2 is ON, it can be known from the formula (1) that: when the path length of the reference voltage line with the reference voltage Vₛₛ is increased, the impedance is increased as well, so that the reference voltage Vₛₛ is raised and generate a pulsating voltage ΔV which leads to a decreasing of driving current I_{OLED} passing the OLED and a reduction of brightness, resulting in a poor image display.

Therefore, it needs an OLED display which can avoid the reference voltage Vss to be raised so as to solve the above-mentioned problems.

### SUMMARY OF THE INVENTION

In one aspect of the invention, it provides an OLED display which can avoid the voltage of the reference voltage line to be raised.

To achieve the objective, the present invention further provides an organic light emitting diode (OLED) display, comprising: a data driving circuit; a scan driving circuit; a display panel, comprising: a plurality of data lines, electrically connected to the data driving circuit; a plurality of scan lines, electrically connected to the scan driving circuit, and the scan lines being across the data lines; a plurality of pixel units, each of the pixel units electrically connected to the corresponding data line and the corresponding scan line and having an OLED element, wherein the pixel units are arranged in a form of array; a plurality of reference power lines, each of the reference power lines electrically connected to the corresponding pixel unit; and a plurality of reference voltage lines, each of the reference voltage line electrically connected to a cathode of the OLED element in the corresponding pixel units; a power supply circuit, electrically with the reference power lines; and a compensation device, electrically with the reference voltage lines, whereby a voltage of the reference voltage line becomes an ideal signal, and the ideal signal is a fixed voltage, and the compensation device comprises: a detecting circuit, being used for detecting the reference voltage line to obtain a pulsation signal; and a compensation circuit, electrically connected to the detecting circuit and being used for outputting a compensation signal to the reference voltage line according to the pulsation signal.

The present invention further provides a method for compensating voltages including steps as follows. A reference voltage line is detected to obtain a first pulsation signal. A phase of the first pulsation signal is shifted to obtain a shift signal. The shift signal is compared with an ideal signal to obtain a difference signal. A phase of difference signal is inverted, and the phase-inverted difference signal is summed up with the ideal signal, so as to obtain a compensation signal. The compensation signal is outputted to the reference voltage line when the reference voltage line sends a second pulsation signal, so that a voltage of the reference voltage line becomes the ideal signal, wherein the ideal signal is a fixed voltage.

In the present invention, a method is used for compensating the voltage of the reference voltage line of an OLED display; therefore, it can prevent the voltage of the reference voltage line to be raised, which can avoid the driving current passing through the

OLED element to be decreased and further stabilize the brightness of the OLED display, so that the image of the OLED display can have an excellent uniformity.

The present invention will become more fully understood from the detailed description given herein below for illustration only, which thus is not limitative of the present invention.

### BRIEF DESCRIPTION OF THE DRAWINGS

FIG. 1 is a pixel unit circuit diagram of a conventional OLED display.

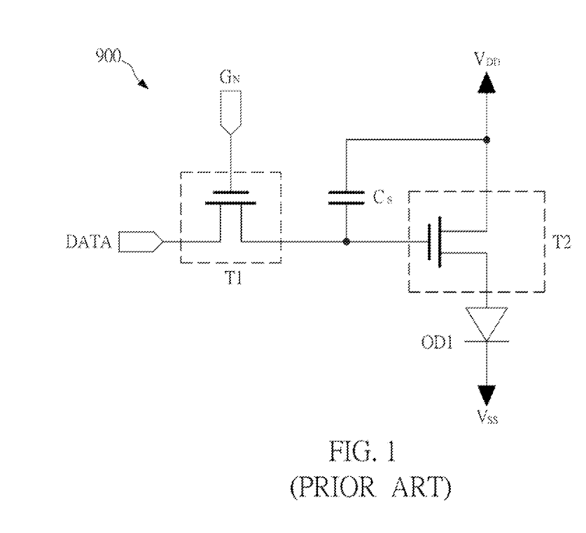

FIG. 2 is a conventional timing diagram of pulsating voltages.

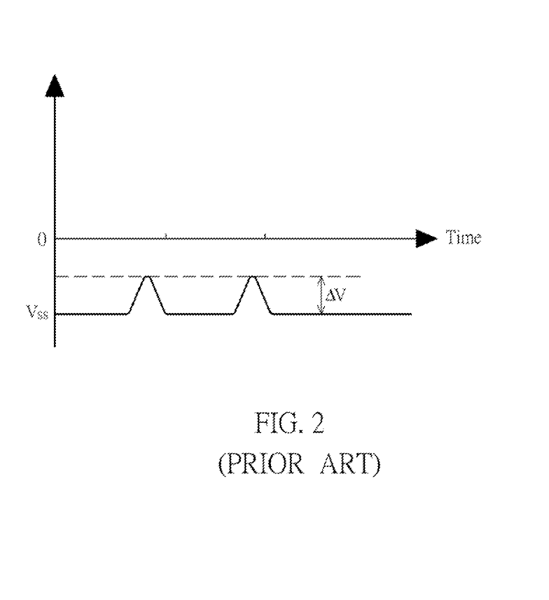

FIG. 3 is a schematic circuit diagram of an OLED display according to an embodiment of the present invention.

FIG. 4 is a structural diagram of a compensation device according to an embodiment of the present invention.

FIG. 5 is a flow chart showing a method of compensating voltages according to an embodiment of the present invention.

FIG. 6 shows a timing diagram of a first pulsation signal, a second pulsation signal, a shift signal, an ideal signal, a difference signal, and a compensation signal.

FIG. 7 is a circuit diagram of an OLED panel of the present invention.

FIG. 8 is a timing diagram of the pulsation and compensation signals.

### DETAILED DESCRIPTION OF THE INVENTION

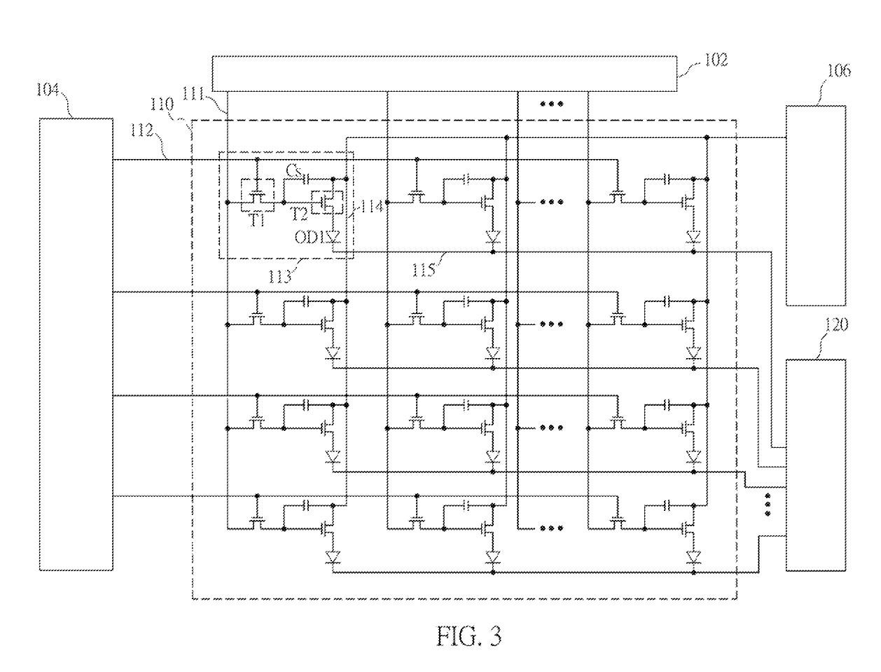

FIG. 3 is a schematic circuit diagram of an organic light emitting diode (OLED) display according to an embodiment of the present invention. The OLED display 100 includes a data driving circuit 102, a scan driving circuit 104, a display panel 110, a power supply circuit 106, and a compensation device 120.

The display panel 110 includes a plurality of data lines 111, a plurality of scan lines 112, a plurality of pixel units 113, a plurality of reference power lines 114 and a plurality of reference voltage lines 115. The data lines 111 are electrically connected to the data driving circuit 102, and the scan lines 112 are electrically connected to the scan driving circuit 104. In addition, the scan lines 112 are across the data lines 111, each of the pixel units 113 is electrically connected to the corresponding data line 111 and scan line 112, and the pixel units 113 are arranged in a form of array. Besides, each of the reference power lines 114 is electrically connected to the corresponding pixel unit 113, and each of the reference voltage line 115 is electrically connected to a cathode of an OLED element OD1 of the corresponding pixel unit 113.

Each pixel unit 113 includes a switching thin-film transistor (TFT) T1, a driving TFT T2, a capacitor Cs, and an OLED element OD1. The switching TFT T1 and the driving TFT T2 have a gate, a drain, and a source, respectively. The gate of the switching TFT T1 is electrically connected to the scan line 112, the drain of the switching TFT T1 is electrically connected to the data line 111, and the source of the switching TFT T1 is electrically connected to the gate of the driving TFT T2. On the other hand, the drain of the driving TFT T2 is electrically connected to the reference power line 114, and the source of the driving TFT T2 is electrically connected to an anode of the OLED element OD1. One end of the capacitor Cs is electrically connected to the gate of the driving TFT T2, and the other end of the capacitor Cs is electrically connected to the drain of the driving TFT T2.

When the scan driving circuit 104 performs N (N is a nature number larger than 1) times scans from top to bottom, the switching TFTs T1 of the pixel units 113 at the same row will be ON in sequence. Then, the signals in the data driving circuit 102 will be transmitted to the corresponding pixel units 113 through the data lines 111 and then stored in the capacitors Cs of the pixel units 113, respectively. When the scan driving circuit 104 makes the switching TFTs T1 of the pixel units 113 OFF, the driving TFTs T2 will be ON and respectively generate a driving current to drive the OLED element OD1 according to the voltage stored in the capacitor Cs.

The power supply circuit 106 is electrically connected to the reference power lines 114 so as to provide a power voltage, and the compensation device 120 is electrically connected to the reference voltage lines 115 so as to stabilize the voltages of the reference voltage lines 115.

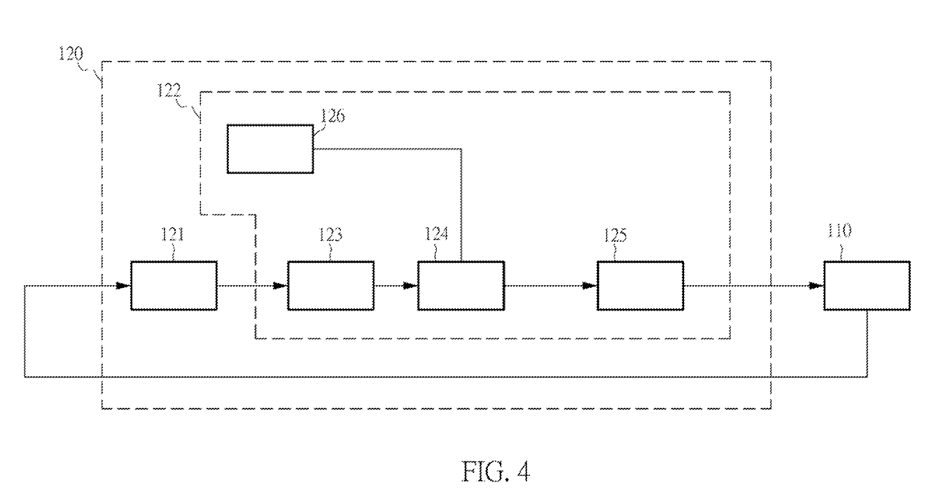

FIG. 4 is a structural diagram of a compensation device according to an embodiment of the present invention. The compensation device 120 includes a detecting circuit 121 and a compensation circuit 122. The detecting circuit 121 is used for detecting the reference voltage line 115, so as to obtain a pulsation signal, and the compensation circuit 122 is electrically connected to the detecting circuit 121, so as to output a compensation signal according to the pulsation signal.

The compensation circuit 122 may further include a shift calculation circuit 123, a differential comparator 124, a difference compensator 125, and a voltage generator 126. The shift calculation circuit 123 is electrically connected to the detecting circuit 121 for receiving the pulsation signal and outputting a shift signal. The differential comparator 124 is electrically connected to the shift calculation circuit 123 and the voltage generator 126 for receiving the shift signal of the shift calculation circuit 123 and the ideal signal of the voltage generator 126. Here, the ideal signal is a fixed voltage. The shift signal and the ideal signal are compared to output a difference signal. The difference compensator 125 is electrically connected to the differential comparator 124 for receiving the difference signal and outputting the compensation signal. In the embodiment, the compensation device 120 and the power supply circuit 106 are separately disposed. In another embodiment, the compensation device 120 may be disposed in the power supply circuit 106.

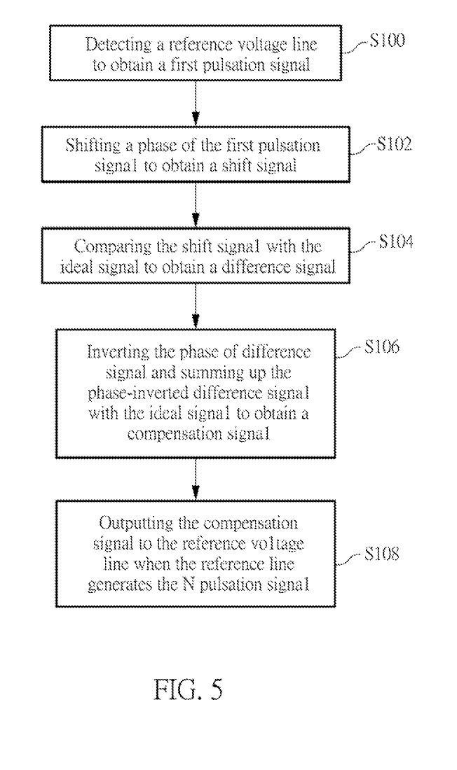

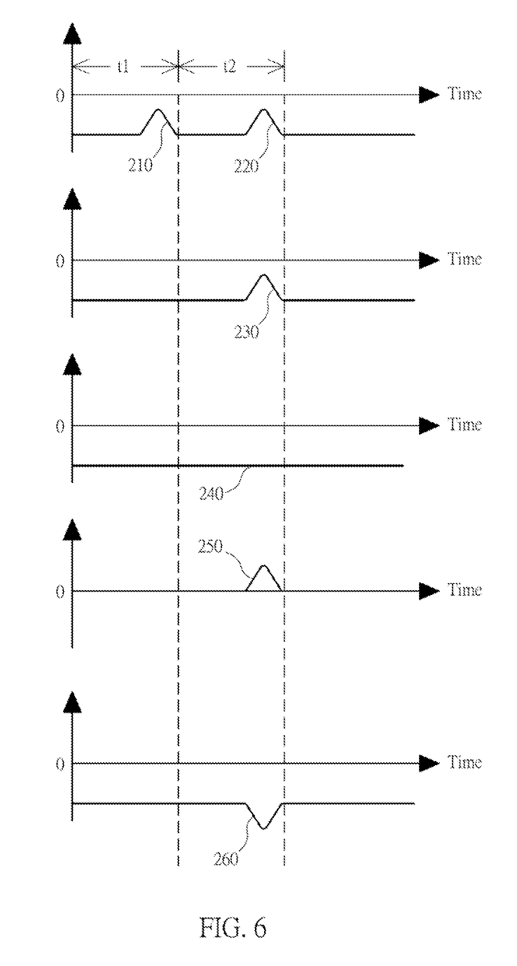

FIG. 5 is a flow chart showing a method of compensating voltages according to an embodiment of the present invention. FIG. 6 shows a timing diagram of a first pulsation signal, a second pulsation signal, a shift signal, an ideal signal, a difference signal, and a compensation signal. In addition, please refer to FIGS. 3 and 4 together. The method of compensating voltages may include the steps as follows:

In step S100: detecting a reference voltage line to obtain a first pulsation signal. When the driving TFT T2 is ON, the impedance is increased because the path length of the reference voltage line 115 is increased, so that the reference voltage of the reference voltage line 115 is raised and generates a pulsating voltage. In this step, the pulsation signal generated in a first period t1 is defined as a first pulsation signal 210. When the reference voltage line 115 generates the first pulsation signal 210, the detecting circuit 121 is used to detect the reference voltage line 115, so as to obtain the first pulsation signal 210. Then, the first pulsation signal 210 is transmitted to the shift calculation circuit 123.

In step S102: shifting a phase of the first pulsation signal to obtain a shift signal. In this step, a shift calculation circuit 123 is used to shift a phase of the first pulsation signal 210, and the phase-shifted first pulsation signal 210 is defined as a shift signal 230, so that there is a phase lag between the first pulsation signal 210 and the shift signal 230.

In step S104: comparing the shift signal with the ideal signal to obtain a difference signal. In this step, the shift signal 230 and an ideal signal 240 are compared by the differential comparator 124, so as to obtain a difference signal 250. Here, the difference signal 250 is obtained by subtracting the ideal signal 240 from the shift signal 230.

In step S106: inverting the phase of the difference signal and summing up the phase-inverted difference signal with the ideal signal to obtain a compensation signal. In this step, after receiving the difference signal 250, the difference compensator 125 inverts the phase of the difference signal 250, and then the phase-inverted difference signal 250 and the ideal signal 240 are sum up together, so as to obtain the compensation signal 260. The voltage value of the compensation signal 260 is less than or equal to the fixed voltage value of the ideal signal 240.

In step S108: outputting the compensation signal to the reference voltage line when the reference line generates the N pulsation signal (for example, the second pulsation signal). In this step, when the reference voltage line 115 generates a second pulsation signal 220 during the second period t2, the difference compensator 125 will output the compensation signal 260 at the same time, so that the second pulsation signal 220 and the compensation signal 260 are neutralized and the signal in the reference voltage line 115 becomes the ideal signal 240.

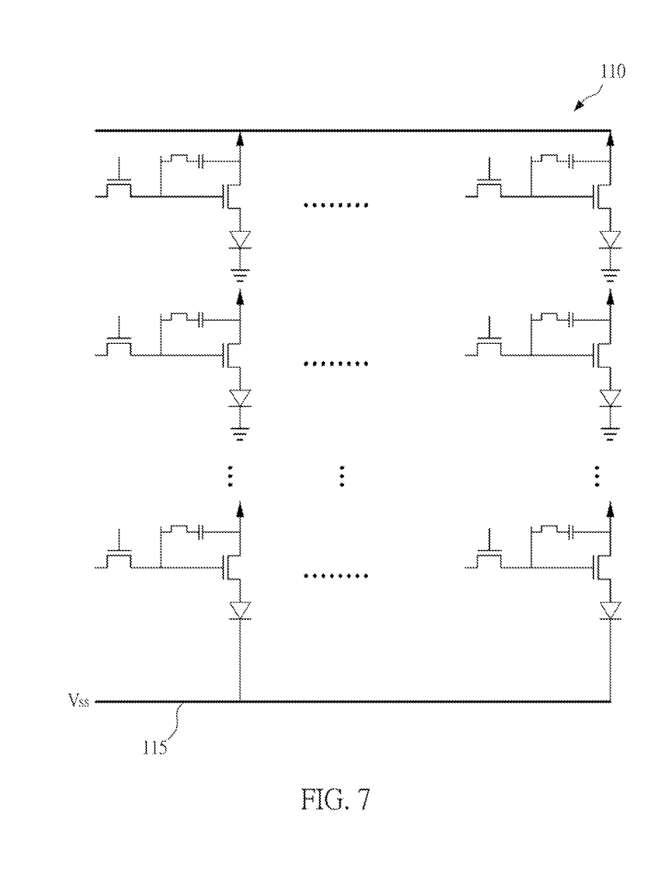

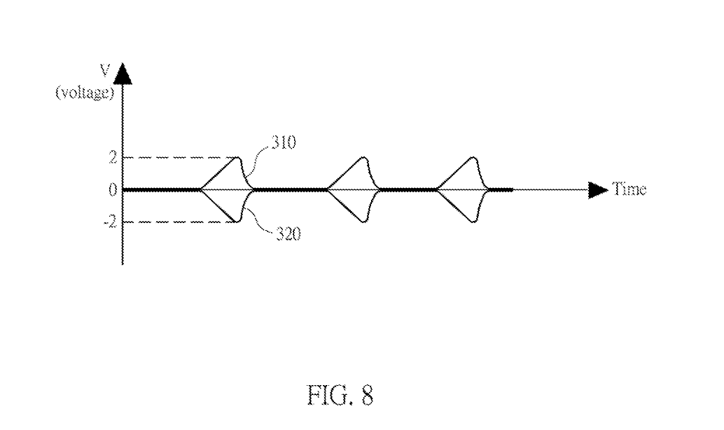

For example, please refer to FIGS. 7 and 8. With the trend of large-size and high resolution displays, when the reference voltage Vss is inputted to a display panel 110 through the reference voltage line 115, the impedance in the circuit of the display panel 110 is increased because the path length of the reference voltage line 115 is increased, so that the voltage in the reference voltage line 115 is raised to 2 volts (voltage) so as to form a pulsation signal 310. Then, a compensation signal 320 is generated by the compensation device 120 shown in FIG. 4 and the method of compensating voltages shown in FIG. 5. The compensation signal 320 is a pulsation signal of −2 volts, and inputted to the reference voltage line 115, so as to neutralize the raised voltage of 2 volts caused by the increased impedance; therefore, the voltage of the reference voltage line 115 can approach to the fixed voltage of the ideal signal. In FIG. 8, the fixed voltage of the ideal signal is 0 volt.

It can be known from above, in the present invention, a method is used for compensating the voltage of the reference voltage line of an OLED display; therefore, it can prevent the voltage of the reference voltage line to be raised, which can avoid the driving current passing through the OLED element to be decreased and further stabilize the brightness of the OLED display, so that the image of the OLED display can have an excellent uniformity.

It will be apparent to persons of ordinary art in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An organic light emitting diode (OLED) display, comprising:
a data driving circuit;
a scan driving circuit;
a display panel, comprising:
a plurality of data lines, electrically connected to the data driving circuit;
a plurality of scan lines, electrically connected to the scan driving circuit, and the scan lines being across the data lines;
a plurality of pixel units, each of the pixel units electrically connected to the corresponding data line and the corresponding scan line and having an OLED element, wherein the pixel units are arranged in a form of array;
a plurality of reference power lines, each of the reference power lines electrically connected to the corresponding pixel unit; and
a plurality of reference voltage lines, each of the reference voltage line electrically connected to a cathode of the OLED element in the corresponding pixel units;
a power supply circuit, electrically with the reference power lines; and
a compensation device, electrically with the reference voltage lines, whereby a voltage of the reference voltage line becomes an ideal signal, and the ideal signal is a fixed voltage, and the compensation device comprises:
a detecting circuit, being used for detecting the reference voltage line to obtain a pulsation signal; and
a compensation circuit, electrically connected to the detecting circuit and being used for outputting a compensation signal to the reference voltage line according to the pulsation signal.

2. The OLED display as claimed in claim 1, wherein the compensation circuit of the compensation device further comprises:
a shift calculation circuit, being used for receiving the pulsation signal and outputting a shift signal;
a differential comparator, electrically connected to the shift calculation circuit, and being used for receiving the shift signal and comparing the shift signal with the ideal signal to output a difference signal; and
a difference compensator, electrically connected to the differential comparator and being used for receiving the difference signal and outputting the compensation signal.

3. The OLED display as claimed in claim 2, wherein the compensation circuit further comprises a voltage generator electrically connected to the differential comparator and used for generating the ideal signal.

4. The OLED display as claimed in claim 1, wherein the compensation device is disposed in the power supply circuit.

5. The OLED display as claimed in claim 1, wherein the compensation device and the power supply circuit are separately disposed.

6. The OLED display as claimed in claim 1, wherein a voltage value of the compensation signal is equal to or less than a fixed voltage value of the ideal signal.

7. The OLED display as claimed in claim 1, wherein the fixed voltage value of the ideal signal is 0 volt.

8. A method for compensating voltages, comprising:
detecting a reference voltage line to obtain a first pulsation signal;
shifting a phase of the first pulsation signal to obtain a shift signal;
comparing the shift signal with an ideal signal to obtain a difference signal, wherein the ideal signal is a fixed voltage;
inverting a phase of difference signal and summing up the phase-inverted difference signal with the ideal signal to obtain a compensation signal; and
outputting the compensation signal to the reference voltage line when the reference voltage line sends a second pulsation signal, so that a voltage of the reference voltage line becomes the ideal signal.

9. The method as claimed in claim 8, wherein a voltage value of the compensation signal is equal to or less than a fixed voltage value of the ideal signal.

10. The method as claimed in claim 8, wherein the difference signal is obtained by subtracting the ideal signal from the shift signal.

11. The method as claimed in claim 8, wherein the reference voltage line is electrically connected to a cathode of an OLED element.
